(19) United States
(12) Patent Application Publication
(10) Pub. No.: US 2013/0045718 A1
(43) Pub. Date: Feb. 21, 2013

(54) Access Level Control Method And Related Service System

(71) Applicant: Ju-Ting Yang, Taoyuan County (TW)

(72) Inventor: Ju-Ting Yang, Taoyuan County (TW)

(21) Appl. No.: 13/584,754

(22) Filed: Aug. 13, 2012

Related U.S. Application Data
(60) Provisional application No. 61/524,333, filed on Aug. 17, 2011.

(51) Int. Cl. H04W 4/12

(52) U.S. Cl. 455/413

(57) ABSTRACT

An access level control method for an EVVM client in a service system is disclosed. The access level control method comprises applying a plurality of access levels on a message corresponding to a plurality of recipients; and forwarding the message to the plurality of recipients.

### CROSS REFERENCE TO RELATED APPLICATIONS

This application claims the benefit of U.S. Provisional Application No. 61/524,333, filed on Aug. 17, 2011 and entitled “Access Level Control Applied on Multiple Recipients in EVVM”, the contents of which are incorporated herein in their entirety.

### BACKGROUND OF THE INVENTION

1. Field of the Invention

The application relates to an access level control method and related service system, and more particularly, for an EVVM (Enhanced Visual Voice Mail) client in an Open Mobile Alliance (OMA) Enhanced Visual Voice Mail (EVVM) working group.

2. Description of the Prior Art

Open Mobile Alliance (OMA) is the focal point for the development of mobile service enabler specifications, which support the creation of interoperable end-to-end mobile services. OMA drives service enabler architectures and open enabler interfaces that are independent of the underlying wireless networks and platforms. OMA creates interoperable mobile data service enablers that work across devices, service providers, operators, networks, and geography. Toward that end, OMA will develop test specifications, encourage third party tool development, and conduct test activities that allow vendors to test their implementations.

In OMA EVVM (Enhanced Visual Voice Mail) working group, it aims to offer a more converged VVM service portfolio offering multiple means of presentation (e.g., email, audio, fax), wider choice of caller languages, more secure and simpler user interface. FIG. 1 presents the EVVM logical architecture model, depicting the EVVM Enabler's functional components and their interactions with each other and with external entities such as the Supporting Enablers and the Remote EVVM Server.

A Message Storage Client (MSC), which performs as the EVVM VM storage client, which resides in the user's Device and allows the EVVM user to use the client side capabilities of CPM Message Storage by interacting with the Message Storage Server (MSS). A Message Storage Server (MSS) provides storage functions for EVVM user's voicemails, personalised greetings and voice signatures including their attachments (e.g., audio, display of logos, advertisements). An Interworking Gateway, which provides interworking between EVVM-based services and external standard non-OMA VM Services. A Forwarding Gateway, which forwards voicemails to external non-VM services such as Email, MMS and SMS. A Transcoder, which resides in the network's Server Domain and serves transcoding requests from other EVVM components.

However, according to current specification, while receiving a voicemail, the EVVM Enabler allows EVVM Clients to forward any voicemail or part(s) of it to the recipient(s) without certain access control of the forwarding mechanism, confidentiality and integrity of the original voicemail can't be ascertained which might lead to defect incomplete functionalities in OMA EVVM.

### SUMMARY OF THE INVENTION

An access level control method for an EVVM client in a service system is disclosed. The access level control method comprises receiving a message; applying a plurality of access levels on the message according to a plurality of recipients; and forwarding the message to the plurality of recipients.

A communication device configured as an EVVM client is disclosed. The communication device comprises a memory unit and a processor. The memory unit for storing a program code corresponding to a process. The processor coupled to the memory unit, for processing the program code to execute the process. The process comprises applying a plurality of access levels on the message corresponding to a plurality of recipients; and forwarding the message to the plurality of recipients.

A communication device configured as an EVVM server is disclosed. The communication device comprises a memory unit and a processor. The memory unit for storing a program code corresponding to a process. The processor coupled to the memory unit, for processing the program code to execute the process. The process comprises receiving a table from the client, in which a plurality of access levels correspond to a plurality of recipients.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an EVVM (Enhanced Visual Voice Mail) logical architecture model in the prior art.

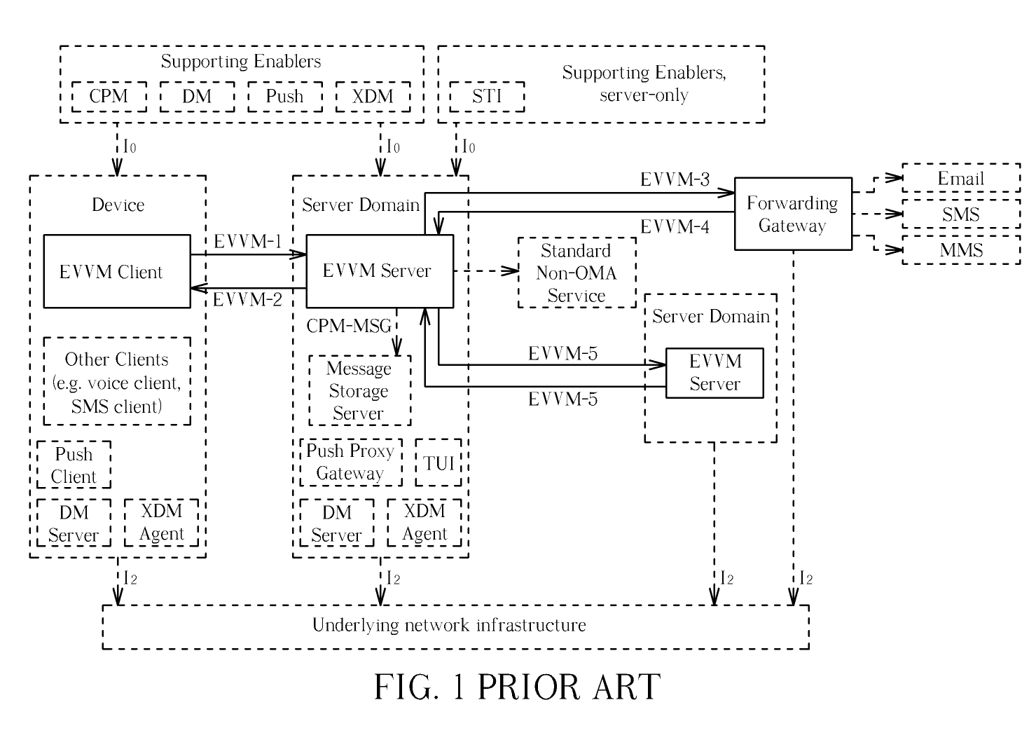

FIG. 2 is a schematic diagram of an exemplary service system.

FIG. 3 is a flow chart of an exemplary process.

### DETAILED DESCRIPTION

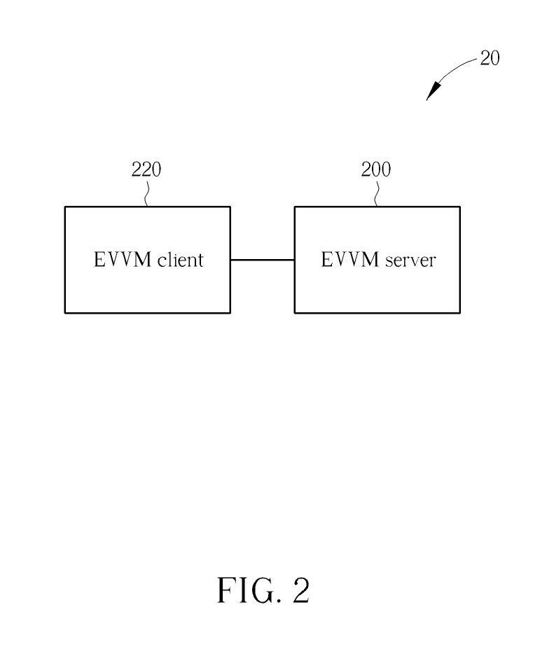

Please refer to FIG. 2, which is an exemplary architecture of a service system 20. The service system 20 complies with a protocol specified by Open Mobile Alliance (OMA) Enhanced Visual Voice Mail (EVVM) working group. The service system 20 includes an EVVM server 200, an EVVM client 220. The EVVM client 220 resides in a device (e.g., a fixed/mobile phone, a desktop/laptop computer, a PDA). It is used to access network-based EVVM functional components and to manage voicemails, greetings and user preferences. User can use multiple EVVM clients (which may reside on multiple devices) to access EVVM based services. The EVVM Server 200 resides in a server domain. It stores resources and provides access to these resources to other EVVM functional components.

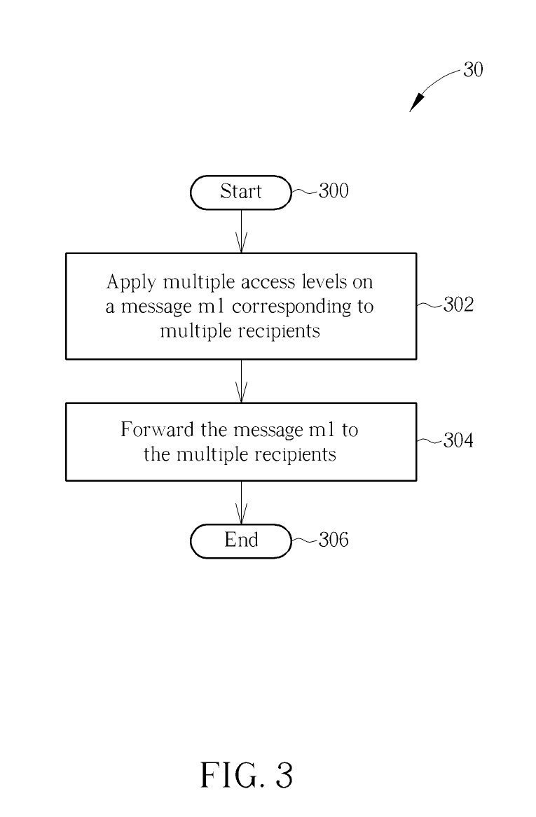

Please refer to FIG. 3, which is a flow chart of an exemplary process 30. The process 30 is used for the EVVM client 220 in the service system 20. The process 30 can be compiled into a program code and include the following steps:

Step 300: Start.

Step 302: Apply multiple access levels on a message ml corresponding to multiple recipients.

Step 304: Forward the message ml to the multiple recipients.

Step 306: End.

According to the process 30, the EVVM client applies the multiple access levels on the message ml corresponding to the multiple recipients when forwarding the message ml to the multiple recipients. Preferably, the message ml is a voicemail. The EVVM client may receive the message ml from the other resources and forward the message ml later on. Or the EVVM client may generate the message ml and send it to the multiple recipients. In other words, the different recipients have different access levels to access the message ml. One access level may correspond to one or more recipients. Each recipient can belong to only one access level at one time.

In some examples, four different access levels are set in advance. They are, from high to low, as follows:

Class 1: TRANSFORM/ADD/MODIFY/FORWARD/COPY/READ. At the level 1, the recipients can read, copy and forward the overall voicemail or message (i.e. message ml), and modify the original voicemail or message, including adding more text or more emotion indications or add his/her personal background music, or even add more attachments. Besides, the EVVM client also allows the recipients to transform the original message into other form of presentation, such as email, audio, fax, MMS, or SMS.

Class 2: ADD/MODIFY/FORWARD/COPY/READ. At the level 2, the recipients can read, copy and forward the overall voicemail or message (i.e. message ml), and modify the original voicemail or message, including adding more text or more emotion indications or add his/her personal background music, or even add more attachments.

Class 3: FORWARD/COPY/READ. At the level 3, the recipients can read, forward and copy the overall voicemail or message (i.e. message ml) to other recipients. They are not allowed to apply “MODIFY”, “ADD”, and “TRANSFORM”.

Class 4: READ. At the level 4, the recipients can only read the voicemail or message (i.e. message ml). They are not allowed to apply “COPY”, “FORWARD”, “MODIFY”, “ADD”, and “TRANSFORM”.

Besides, the EVVM client can set a table. In the table, the access levels correspond to the recipients. The EVMM client stores the table and dynamically updates or changes the table to reflect the current client's preference and setting. The EVVM client informs the EVVM server of the table (e.g. through a message). When the EVVM server receives the table, the EVVM server stores the table.

For example, a table 1 1 with 4 different access levels is provided below for elaboration. In the table 1, there are 12 recipients A, B, C, D, E, F, G, H, I, J, K, L in this scenario. Class 1 is the highest access level.

TABLE 1

| Access | Allowed Actions on the | |
|---|---|---|
| Level | Received Message | Recipients |
| Class1 | TRANSFORMADD/MODIFY/ | A, L |
| | FORWARD/COPY/READ | |
| Class2 | ADD/MODIFY/FORWARD/ | D, E, F, I |
| | COPY/READ | |
| Class3 | FORWARD/COPY/READ | B, H, J, K |
| Class4 | READ | C, G |

As seen in the table 1, the recipients A, L belong to the highest access level, Class 1, and they are allowed to read, copy, forward the original message, add new emotion indications and attachments ad also transform the original message into other means of presentation. The recipients D, E, F, I belong to the second access level, Class 2, and they are allowed to read, copy, forward the original message, and even add new emotion indications and attachments. The recipients B, H, J, K, G belong to the third access level, Class 3, and they are allowed to read, copy, forward the original message. Modification and Adding on the original message is not permitted. The recipient C belongs to the lowest access level, Class 4, and he/She is only allowed to read, the original message. Copying, Forwarding, modification and Adding on the original message is not permitted. Please note that the number of the access level is not limited to four, and the action applied on each class is not limited to what is proposed here.

To sum up, when the EVVM client forwards a message to the multiple recipients, the EVVM client applies the multiple access levels on the message corresponding to the multiple recipients. The recipients can read, copy, forward the message or modify the message according to the access level.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An access level control method for an EVVM (Enhanced Visual Voice Mail) client in a service system, the access level control method comprising:
applying a plurality of access levels on a message corresponding to a plurality of recipients; and
forwarding the message to the plurality of recipients.

2. The access level control method of claim 1 further comprising setting a table, in which the plurality of access levels correspond to the plurality of recipients, storing the table in the EVVM client and dynamically updating or changing the table.

3. The access level control method of claim 2 further comprising informing an EVVM server of the table.

4. The access level control method of claim 3, wherein the EVVM server stores the table when receiving the table.

5. The access level control method of claim 1, wherein the plurality of access levels comprises:
a first access level, at the first access level the message is allowed to be transformed, added, modified, forwarded, copied or read;
a second access level, at the second access level the message is allowed to be added, modified, forwarded, copied or read;
a third access level, at the third access level the message is allowed to be forwarded, copied or read; and
a forth access level, at the forth access level the message is allowed to be read.

6. The access level control method of claim 1, wherein the message is a voicemail.

7. The access level control method of claim 1, wherein the service system is complied with an OMA EVVM (Open Mobile Alliance, Enhanced Visual Voice Mail) specification.

8. A communication device configured as an EVVM client, comprising:
a memory unit for storing a program code corresponding to a process; and
a processor coupled to the memory unit, for processing the program code to execute the process;
wherein the process comprises:
applying a plurality of access levels on the message corresponding to a plurality of recipients; and
forwarding the message to the plurality of recipients.

9. The client of claim 8, wherein the process further comprises setting a table, in which the plurality of access levels correspond to the plurality of recipients, storing the table in the EVVM client and dynamically updating or changing the table.

10. The client of claim 9, wherein the process further comprises informing a server of the table.

11. The client of claim 8, wherein the plurality of access levels comprises:
a first access level, at the first access level the message is allowed to be transformed, added, modified, forwarded, copied or read;
a second access level, at the second access level the message is allowed to be added, modified, forwarded, copied or read;
a third access level, at the third access level the message is allowed to be forwarded, copied or read; and
a forth access level, at the forth access level the message is allowed to be read.

12. The client of claim 8, wherein the message is a voicemail.

13. The client of claim 8, wherein the client is complied with an OMA EVVM (Open Mobile Alliance, Enhanced Visual Voice Mail) specification.

14. A communication device configured as an EVVM server, comprising:
a memory unit for storing a program code corresponding to a process; and
a processor coupled to the memory unit, for processing the program code to execute the process;
wherein the process comprises:
receiving a table from the client, in which a plurality of access levels correspond to a plurality of recipients.

15. The server of claim 14, wherein the process further comprises storing the table when receiving the table.

16. The server of claim 14, wherein the plurality of access levels comprises:
a first access level, at the first access level the message is allowed to be transformed, added, modified, forwarded, copied or read;
a second access level, at the second access level the message is allowed to be added, modified, forwarded, copied or read;
a third access level, at the third access level the message is allowed to be forwarded, copied or read; and
a forth access level, at the forth access level the message is allowed to be read.

17. The server of claim 14, wherein the server is complied with an OMA EVVM (Open Mobile Alliance, Enhanced Visual Voice Mail) specification.
